(19) United States
(12) Patent Application Publication
(10) Pub. No.: US 2012/0327410 A1
(43) Pub. Date: Dec. 27, 2012

(54) NON-CONTACT MEDIA DETECTION SYSTEM USING REFLECTION/ABSOPTION SPECTROSCOPY

(75) Inventor: Robert A. Maston, Columbus, OH (US)

(73) Assignee: CVG MANAGEMENT CORPORATION, New Albany, OH (US)

(21) Appl. No.: 13/167,258

(22) Filed: Jun. 23, 2011

(51) Int. Cl. G01J 3/30; G01J 3/00

(52) U.S. Cl. 356/307; 356/300

(57) ABSTRACT

The innovation uses the response of media to electromagnetic (EM) signals in order to identify them. When EM sources are directed at a target medium, a response is obtained from an EM detector observing the event. By comparing a measured response to a library of known profiles, one or more likely candidates for the target medium can be determined.

### BACKGROUND

Media—materials or object of various textures, purity, and colors—can be identified or sensed in a variety of ways. Humans are equipped with five primary senses to gather information about the surrounding environment. Human vision provides a basic way of detecting what is around us by the amount of light it reflects, changes the path of (refraction), or absorbs. When an object absorbs a relatively large amount of light, it appears darker than other objects, approaching black for highly absorptive media. When an object has a particular color it is absorbing more of that color band, or wavelength of light relative to other wavelengths. For example, a lime can be readily recognized from a lemon as a result of their different light absorption characteristics. Light, as detectible by the human eye, covers only a portion of a much wider spectrum of electromagnetic energy. All matter will interact with a wide range of wavelengths in the electromagnetic spectrum both inside and outside the visible light bands. This interaction occurs in energy exchanges at the quantum level. This interaction, the effect of matter and energy change in the presence of electromagnetic energy, is the essence of media identification spectroscopy.

One method of identifying materials is through the use of spectroscopy such as reflection/absorption (R/A) spectroscopy. By directing electromagnetic energy at a target and observing the reflected and absorbed energy levels the media identification can be inferred as a function of energy returned at select known wavelengths. Traditionally, spectroscopy identification methods require elaborate laboratory equipment such as precision lasers, high quality optics and filters, diffraction grating, intricate moving parts, and precision electronic devices.

In addition to measuring the returned energy of a certain transmitted and reflected wavelength, certain media are known to exhibit other properties such as fluorescence. When these effects occur, the reflected energy, which may have a wavelength other than the wavelength of the excitation source, can also be captured.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a non-contact media detection system. The system can have one or more electromagnetic (EM) sources that direct EM energy toward a target surface of an unknown medium and one or more EM detectors that measure EM energy reflected from the target surface of the unknown medium. Additionally, the system can have a control component that receives measurement data from the one or more EM detectors, determines a measured profile based at least in part on the measurement data, and analyzes the measured profile to determine one or more likely candidates for the medium based at least in part on the analyzed profile.

In other aspects, the innovation can include a method of non-contact media detection. The method can include the step of conducting a sequence of one or more measurement steps, wherein each measurement step comprises activating one or more electromagnetic (EM) sources to reflect an EM signal off of an unknown medium and making one or more reading of an intensity of the reflected EM signal with one or more EM detectors. Additionally, the method can include the steps of assembling the one or more readings from each measurement step into a measured profile and determining one or more likely candidates for the unknown medium based at least in part on the measured profile.

In some embodiments, the innovation can comprise a non-contact media detection system. The system can have means for reflecting an EM signal off of an unknown medium at least once for each of one or more measurement steps in a sequence. Additionally, the system can have means for making one or more reading of an intensity of the reflected EM signal once for each measurement step and means for determining one or more likely candidates for the unknown medium based at least in part on the one or more readings of the intensity.

In certain embodiments, the innovation relates to Reflection/Absoption (R/A) spectroscopy-based media identification systems, and methods related thereto. The innovation actively directs Electro-Magnetic (EM) energy toward objects using one or more EM source(s). One or more EM detectors in the system can observe this energy-media interaction and produces medium specific signals. The resulting signals are processed and interpreted to infer the identity of the medium.

Typical medium identification processes involve visual image recognition systems with sophisicated software algorithms to decern object properties, mimicking the mental thought processes of humans to contruct a comparison color or greyscale and form-factor discernable image for comparison with an expected range of items. However, the subject innovation can use one or more simple EM energy producing devices, such as LEDs of known wavelength, and one or more simple receptor devices, such as a photodiode or CCD to capture the resultant EM energy reflection.

Accordingly, the innovation can deliver an inferred result as to which media has been observed using simple technology and principals describe above. With specifically selected component wavelengths in quantities sufficient for unique discernment between possible canidate media, the system can vary in component count as dictated by an application. As an illustrative example, green apples may be distinguished from red apples by use of a relatively small number of EM sources, such as a green and red LED system. Green apples will return a lower green to red ratio when both wavelengths are transmitted and observed by the detector.

Readily available on today's market are an increasing number of light emitting diodes (LEDs). LED technology is advancing to cover an expanding spectrum of energy extending from long wavelength infrared, through the visible light spectrum and into the UV group of wavelengths. These components can be used to direct energy at targets and the medium's intrinsic reflected responses can be readily detectible with simple wide spectrum detectors, such as photo diodes or charge coupled devices (CCDs). The detected responses can be processed and cross-referenced to profiles of known media and the best possible match produced to infer the media identity.

Systems and methods of the subject innovation are capable of discerning between various media in multiple ways, based for example, on whether the media are categorized in a library of known medium profiles or whether medium identification can be inferred based on calculable and quantifiable medium characteristics and thus identified by profile response type. Furthermore, new media can be ‘learned’ by the system as the presented medium's response can be measured and recorded by the system in situ.

Systems and methods of the subject innovation can be deployed without physical contact. Additionally, the excitation source and detector can be physically housed together, as the energy passing into or through the sample is not needed. Because of this, the subject innovation can be used in situations where objects are in motion, for example, in vehicular applications, or where the media is in motion such as in a continuous process. The ability for the system to be self-contained allows it to function in small confined spaces.

In various embodiments, one or more EM detectors can be used, with potential advantages for each embodiment. Although typical simple EM or light detecting systems vary in sensitivity over various wavelength and temperatures, the use of a single detector can allow common drift cancellation and preserve the relative response profiles over the wide range of wavelength sources. Detector signal normalization or auto-gaining can also be employed so that the spectral response characteristics needed for unique media identification can be preserved. This can be beneficial when uniform levels of dirt accumulation, electrical component drift, and aging, to a first order extent, is encountered in a self-contained system.

In yet another aspect thereof, an artificial intelligence component can be provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example of a non-contact media detection system in accordance with one aspect of the subject innovation.

FIG. 2 shows an example embodiment of a non-contact media detection system that illustrates principles of operation associated with the subject innovation.

FIG. 3 illustrates an example non-contact media detection device associated with aspects of the subject innovation.

FIG. 4 illustrates an example schematic of a system associated with aspects of the subject innovation.

FIG. 5 illustrates example media profiles.

FIG. 6 illustrates optical treatments that can be used in connection with the systems and methods described herein.

FIG. 7 illustrates an example operational sequence for a method of non-contact media detection.

FIG. 8 illustrates an example correction that can be applied to a profile of a medium.

FIG. 9 illustrates photographs of a flower in the visible and ultraviolet spectrum, and a corresponding example medium profile.

FIG. 10 illustrates an example configuration wherein a system of the subject innovation can be used to detect media on a road surface while operating in conjunction with a sensor to detect road temperature.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

As will be described in greater detail infra, the subject innovation provides for identification of various media types using a non-contact media detection system. Aspects of the innovation can effectively excite, measure, analyze, and determine the presense of certain media, materials, surface textures, colors, etc. As will be understood, non-contact media detection sensitivity can vary by the presense of externally present ambient EM energy sources, such as bright sun light. These and other environmental factors can be accounted for in a variety of ways, such as adaptive leveling of the one or more EM detector signals during a period wherein the one or more EM source are in an off state, optionally in concert with one or more other techniques, such as variable source power or received signal profile normalization. In addition to handling variations in background EM levels the subject innovation is also effective for handling temperature or aging effects of the system components. This adaptive compensation enhances the accuracy and dynamic range of such systems.

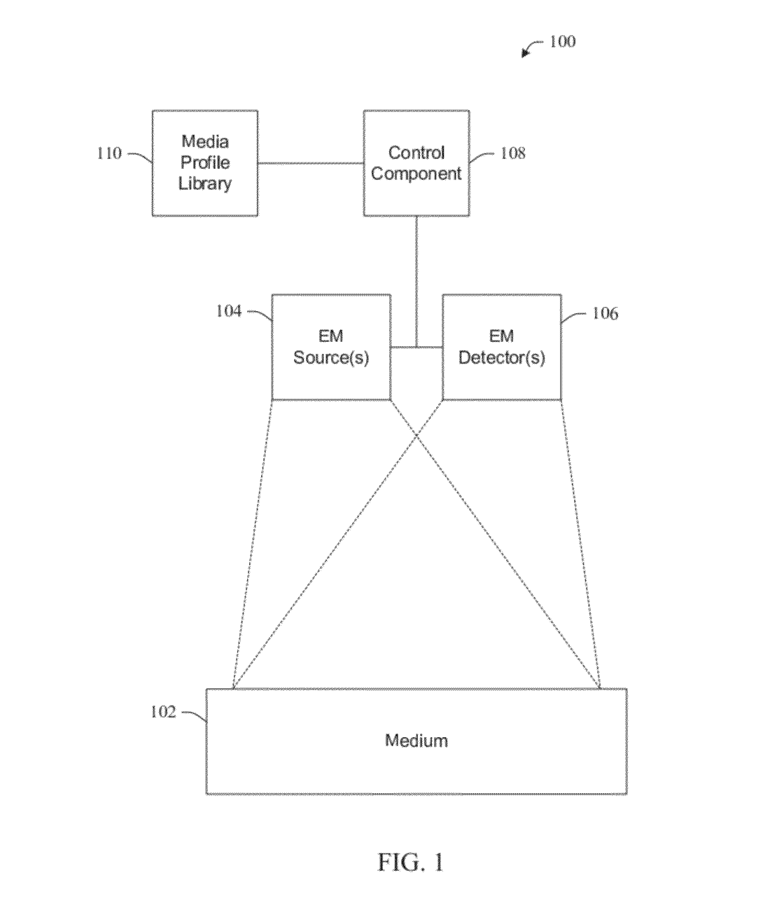

Referring initially to FIG. 1, illustrated is an example of a non-contact media detection system 100 in accordance with one aspect of the subject innovation. Non-contact media detection system 100 can identify a medium 102 based on the interaction between the medium 102 and electromagnetic (EM) radiation or energy (e.g., infrared, visible light, ultraviolet, etc.). System 100 can include one or more EM sources 104 that can produce EM signals, each of which can correspond to one or more wavelengths.

In some embodiments, discussed further herein, each EM source 104 can produce a single disparate wavelength of light. However, in other embodiments, at least one of the EM sources 104 can emit multiple wavelengths, which may or may not overlap with one or more wavelengths of another source. These EM sources 104 can be any of a variety of types of sources, e.g., light emitting diodes (LEDs), lasers, narrow or broad spectrum sources, collimated or non-collimated sources, filtered or not, etc. The one or more EM sources 104 can illuminate at least a portion of medium 102 with EM energy. EM energy interacts with the medium at a quantum level and, in general, the incident EM energy can be partly reflected by the medium, and partly absorbed or transmitted by the medium (although in some situations, none or all may be reflected, or none or all may be absorbed).

Each of the one or more EM sources 104 can be exercised independently or in selective group concert to illuminate at least a portion of the medium 102 so as to produce a detectable response that can be measured by the one or more EM detectors. The one or more EM sources can be operated in various manners, including, but not limited to, simple on/off, variable continuous excitation, and pulse modulation source activations, as well as evaluations of steady-state, peak, root-mean-square (RMS), or decay responses, as well as other manners or combinations of the foregoing.

The non-contact media detection system 100 may also include at least one EM detector 106, which can detect at least a portion of the reflected EM energy from medium 102. The at least one EM detector 106 may consist of a single wide spectrum device, several narrow band devices, or a combination of devices including both wide spectrum and narrow band devices. Examples of EM detectors that can be used are photodiodes, single-pixel cameras, charge-coupled device (CCD) cameras, etc. The at least one EM detector 106 can collect data based on measured levels of EM energy for one or more wavelengths of EM energy emanating from medium 102, generally as reflected EM energy (although other processes, such as photoluminescence, flourescence, and phosphorescence may also contribute). The one or more EM detectors 106 can send the collected data to control component 108 for acquisition and processing (e.g., by converting the collected data into an electrical signal, wirelessly, etc.).

Control component 108 can be connected to the one or more EM sources 104, the one or more EM detectors 106, or both. The control component 108 can independently control the one or more EM sources 104 in a variety of ways. For example, the one or more EM sources 104 can be operated to illuminate the medium with a plurality of wavelengths of EM energy sequentially or simultaneously, with a plurality of narrow bands of wavelengths sequentially or simultaneously, with the one or more EM sources 104 sequentially or simultaneously, etc. Additionally, the control component 108 can receive and process signals or measurement data from the one or more EM detectors 106. The control component 108 can analyze the processed signals or data to determine one or more likely candidates for the medium based at least in part on the analyzed signals or data. This determination can be based at least in part on a comparison of the processed signals to one or more profiles of known media in a media profile library 110. Optionally, the control component 108 can control the one or more EM sources 104 and the one or more EM detectors 106 to sample the optical properties of the medium multiple times before determining the one or more likely candidates. Additionally or alternatively, multiple samples can be taken on an intermittent or ongoing basis, and the one or more likely candidates can be revised based at least in part on the multiple samples taken on an intermittent or ongoing basis. In some aspects, the control component 108 can compare the analyzed signals to a library of known media such as media profile library 110 to find a best match, or one or more likely candidates. In various embodiments, media profile library 110 can be stored one or more of locally or remotely.

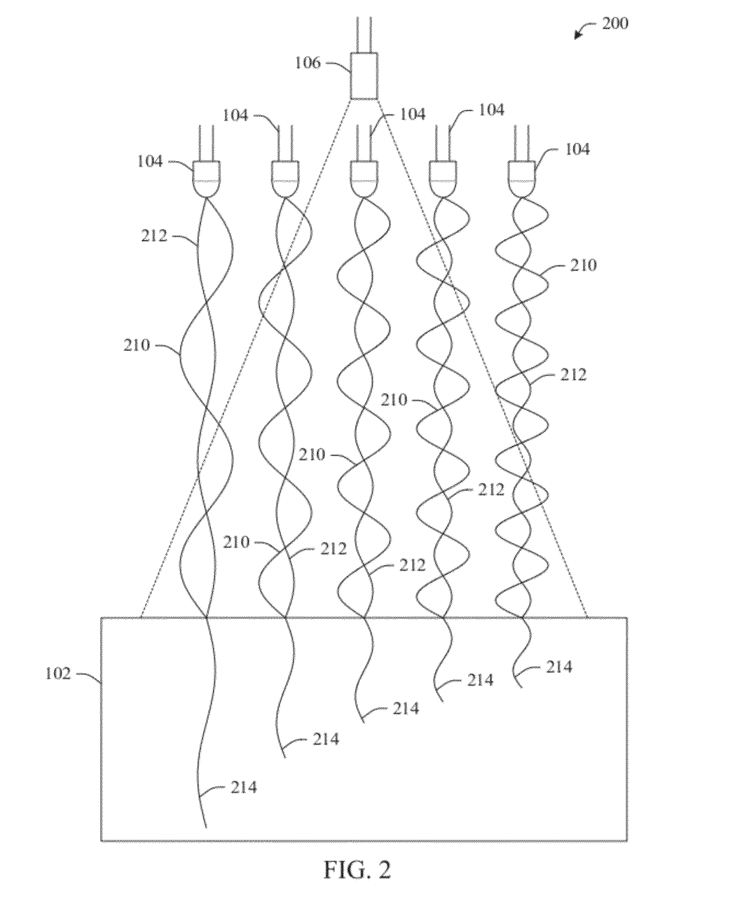

FIG. 2 shows an example embodiment of a non-contact media detection system 200 that illustrates principles of operation associated with the subject innovation. In example system 200, a configuration is shown that includes one or more EM sources 104, which as shown in FIG. 2, can each correspond to one or more disparate wavelengths from one another. Each of the one or more EM sources 104 can produce emitted EM energy 210, represented in FIG. 2 as relatively high amplitude sinusoidal waves between the one or more EM sources 104 and the medium 102. In general, the emitted EM energy 210 can be partly reflected by the medium as reflected EM energy 212, and partly absorbed or transmitted by the medium as transmitted EM energy 214 (although in some situations, none or all may be reflected, or none or all may be absorbed). In general, the portions of reflected EM energy 212 or transmitted EM energy 214 can vary based on the wavelength of the EM energy. Depending on the media, the portion of reflected EM energy 212 or transmitted EM energy 214 at each wavelength may vary, as can be described by a reflection or absorption spectrum that is characteristic of the medium. In general, the one or more EM detectors 106 can detect a portion of the reflected EM energy 212. Control component 108 (not shown in FIG. 2) can use the detected portion of the reflected EM energy 212 to determine one or more likely candidates for the medium as described herein, and this can be done by comparison to profiles stored in media profile library 110 (also not shown in FIG. 2).

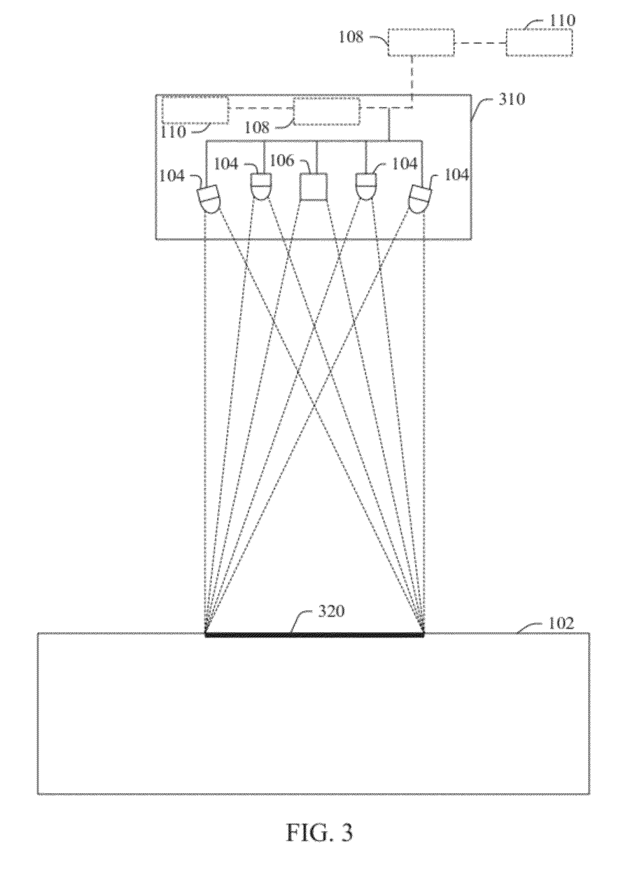

FIG. 3 illustrates an example non-contact media detection device 310 associated with aspects of the subject innovation. Although FIG. 3 illustrates more than one EM source 104 and a single EM detector 106, this is only an example, and these aspects can vary as described herein. The one or more EM sources 104 and the one or more EM detectors 106 can be incorporated in a common device 310. Additionally, the one or more EM sources 104 and one or more EM detectors 106 can be arranged such that a common test area 320 of the medium 102 can be illuminated by the one or more EM sources 104 and monitored by the one or more EM detectors 106. Additionally, device 310 can, in various aspects, either include control component 108 and media profile library 110, or communicate with an external control component 108 and media profile library 110. In some aspects with an external control component 108, the control component 108 can communicate with and analyze data from more than one device 310.

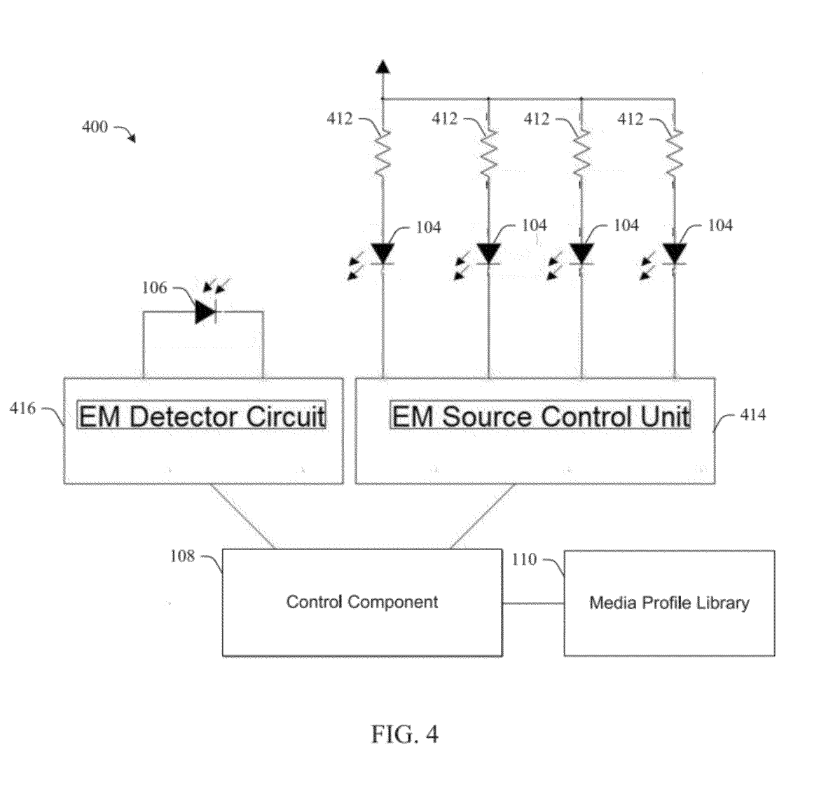

FIG. 4 illustrates an example schematic of a system 400 associated with aspects of the subject innovation. As shown in example system 400, the one or more EM sources 104 can include LEDs, and the one or more EM detectors 106 can include photodiodes. System 400 can also include one or more additional circuit elements 412, such as the resistors depicted in FIG. 4. Optionally, system 400 can include an EM source control unit 414, which can interface with the control component 108 and can allow the control component 108 to individually or collectively control the one or more EM sources 104. Also, system 400 can optionally include EM detector circuit 416, which can interface with the control component 108 and can allow the control component 108 to individually or collectively control the one or more EM detectors 106. Optionally, control component 108 can communicate with media profile library 110.

Systems and methods of the subject innovation can be used to determine one or more likely candidates for a medium by comparing measurements obtained to one or more known media profiles. A collection of commonly expected media profiles can be maintained in a media profile library such as library 110. The location can be maintained locally, remotely, or a combination of the two. These commonly expected media profiles can be determined externally, or in situ, and optionally can be determined ahead of time and transferred to the library, or can have media profile information communicated to it from a remote source either ahead of time or as one or more updates to an already deployed system or device of the subject innovation. Additionally, in some aspects, media profile information obtained in situ can be used to provide additional data to further improve media identification locally, remotely, or both.

In operation, the media profile information can be used in conjunction with other aspects of the subject innovation. For example, the one or more EM sources can be activated to produce a response from the medium (e.g., reflected EM energy, fluorescence, etc.) that can be detected by the one or more EM detectors. Data associated with the detected response can be acquired by the control component, and analysis (e.g., probalistic, etc.) can be executed to compute the closest media profile match. Based at least in part on the analysis, the identity of the medium can be inferred.

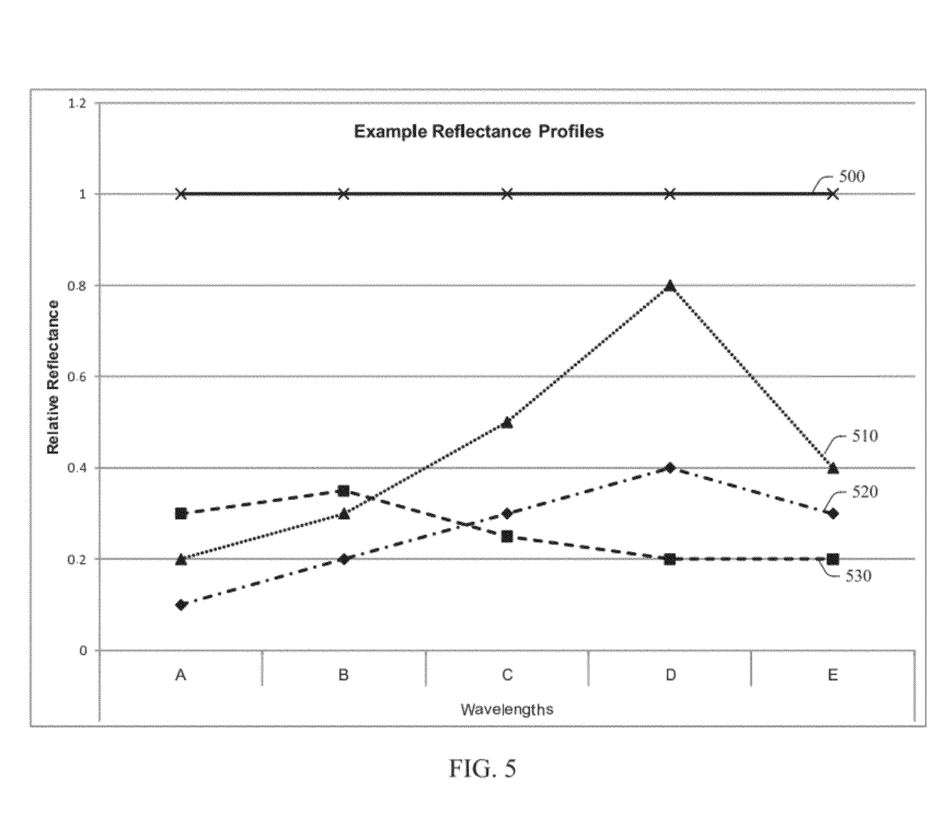

FIG. 5 illustrates example media profiles 500-530. These examples demonstrate some of the concepts discussed herein. As seen in FIG. 5, each of profiles 500-530 can describe the reflectance of a medium to EM energy of at one or more wavelengths, such as wavelengths A-E in FIG. 5. Profile 500 corresponds to a calibration standard of uniformly high reflectance, which can be used to calibrate a system or device in aspects of the subject innovation. In general, the reflectance of a given medium varies by wavelength, as seen in profiles 510, 520, and 530. Although for purposes of illustration, a single reflectance per wavelength is shown for each of profiles 510-530, in operation, one or more media may have more complicated profiles than those shown in FIG. 5. For example, the relative intensity of EM energy at a given wavelength that is measured at the one or more EM detectors after reflection from a medium may vary for a variety of reasons, such as noise (e.g., additional light sources, obscuring material such as fog, etc.), orientation of the surface of the medium, heterogeneity of the medium (e.g., composition and particle size of the medium, such as blacktop, asphalt, cement, concrete, dirt, gravel, rain water, snow, ice, etc.), as well as other factors. Because of this, a profile for a medium can include variations based on the above and other factors, and may include multiple potential reflectance values (e.g., a range, etc.) for a material at each wavelength. These profiles can be obtained through substantially any means discussed herein, including building them by training a system or method of the subject innovation.

Although only four media profiles are shown in FIG. 5, in operation a library such as media profile library 110 can include substantially any number of media profiles, and can include one or more profiles for each medium that a system or device of the subject innovation could encounter in operation in the application for which it is to be employed. For example, if the system or device is to be employed to monitor the road surface beneath a vehicle, various road types (e.g., concrete, asphalt, etc.) and other media that can occur on roads (water, snow, ice, oil, etc.) can be included in the library. Certain vehicles, depending on their applications and those of a system or device used therewith, may optionally use additional media profiles. For example, vehicles used to treat road surfaces (e.g., with salt or other materials, etc.) could use a medium in the road treatment (e.g., something with an easily discernable profile when compared with the road surface or other expected media such as ice or snow, such as a UV or IR tracer added to a salt treatment, etc.). A profile for this material could be used to determine whether the road surface had already been treated or not, and thus, road treatment materials could be conserved. Additionally, other collections of media profiles can be assembled for other applications, as would be apparent in light of the discussion herein. In aspects, these collections of media profiles can be obtained as needed, and can be obtained based at least in part on contextual factors (e.g., temperature, location, etc.).

Identification of a medium (or likely candidates for the medium) can occur based on a comparison of measurements of the medium to one or more media profiles in a library. Thus, in aspects, profiles of media likely to be encountered can be compiled in a library such as library 110 before encountering the media.

The one or more EM detectors 106 can be set to a baseline level by sensing a baseline reference measurement. This baseline can be observed with all of the one or more EM sources 104 off, and can be obtained with a relatively low ambient EM energy level (low light condition). In other aspects, the baseline can be recalibrated at intervals to correspond to a current ambient EM energy level.

In aspects, the media profiles in media profile library 110 can be obtained by operation of a system or device of the subject innovation. In one example method of learning a medium profile (or, alternatively, identifying an unknown medium), the one or more EM sources 104 can be sequenced, with or without variable amplitude modulation, to produce a response from the medium that is measured by the one or more EM detectors 106. The activations of the one or more EM sources 104 and the corresponding responses measured by the one or more EM detectors 106 can be analyzed by the control component 108. If the sequence is being performed for training to learn a profile of a medium, then the analysis results can be stored as or added to a profile for the medium in the library 110. If an unknown medium is being identified, the results of the analysis can be compared to known profiles in library 110 to determine one or more likely candidates for the medium.

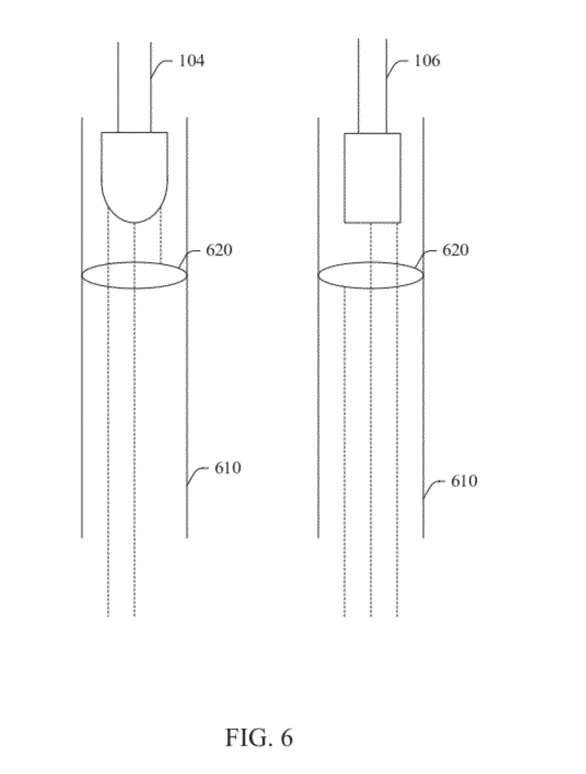

FIG. 6 illustrates optical treatments that can be used in connection with the systems and methods described herein. These optical treatments can be used in connection with one or more EM sources 104 or EM detectors 106. Optical treatments can be used for a variety of purposes, for example, to enhance the selectivity, narrow the object focus, or to increase the energy densities of EM signals produced or received by the one or more EM sources 104 or EM detectors 106. For example, collimators 610 can be employed to collimate the signals produced or received. Additionally, filters 620 can be employed to selectively remove all or parts of specific portions of an EM signal produced or received, for example, by selectively removing or allowing certain wavelengths (e.g., infrared, ultraviolet, specific colors, etc.), certain polarizations, etc.

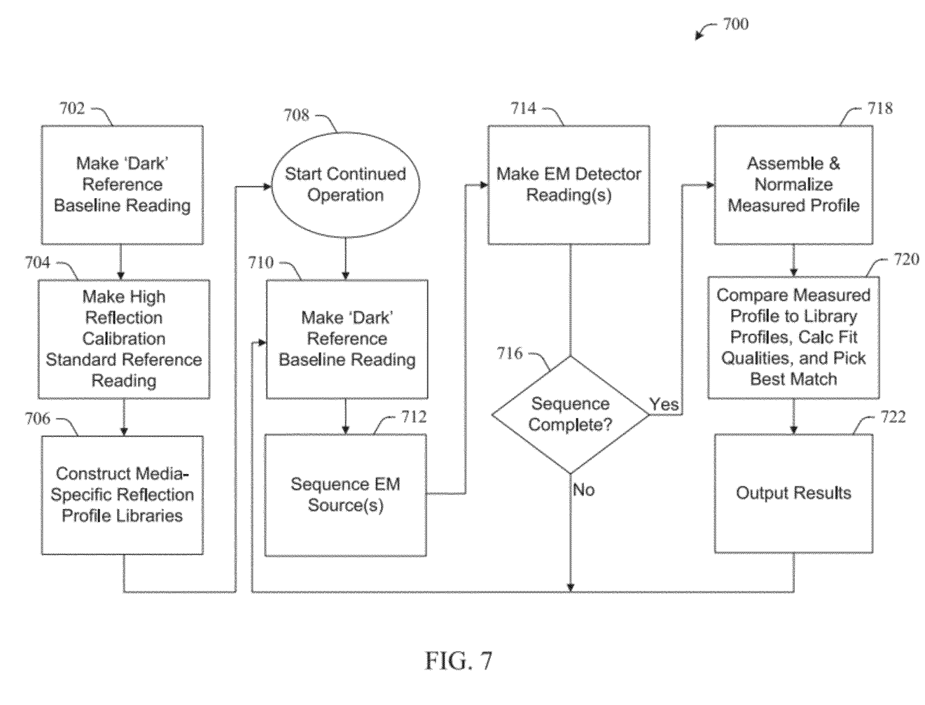

FIG. 7 illustrates an example operational sequence 700 for a method of non-contact media detection. In an optional training portion, a media profile library can be contsructed prior to continued operation. This training period can begin at 702, where one or more ‘dark’ reference baseline readings can be made, meaning that no EM sources are active during the reading. However, these ‘dark’ reference baseline readings can correspond to one or more different levels of ambient lighting. The training portion can continue at 704, wherein one or more reference readings can be taken with a high reflection calibration standard as a reference medium. These readings can be used to calibrate one or more EM detectors to determine a maximum received signal, and can be performed in various conditions. If necessary, the sensitivity of the one or more EM detectors or the intensity of the one or more EM sources can be adjusted, for example, if the detector would be saturated. Any such adjustments can vary based on various conditions, such as variations in ambient lighting, for example to ensure that an EM source is sufficiently detectable over background noise. As an optional step of the training portion, at 706, a library of media-specific reflection profiles can be constructed. For each medium to have a profile added to the library, readings can be taken for one or more wavelengths and in one or more of various conditions.

Continued operation of the non-contact media detection system can begin at step 708. At step 710, one or more ‘dark’ reference baseline readings can be made by each of the one or more EM detectors. The one or more EM detectors can periodically record a ‘dark’ measurement by recording a measurement with all of the one or more EM sources off. These ‘dark’ measurements can be used to form one or more baseline reference point. In aspects, a ‘dark’ reference baseline reading can be made with varying frequency, such as between each sequence, more than once per sequence, or less than once for each sequence, such as once every several sequences, or after specific intervals. Both an ambient reference point and a noise floor can thus be captured, allowing for the ability to adapt to various operating conditions through periodic updates via ‘dark’ measurements. In addition, a power level of the one or more EM source power may be modulated in response to the sensed bias level and noise floor to elevate one or more dark to excited state signal ratios. Similarly, the one or more EM source power levels may be adjusted as needed to prevent saturation of the one or more EM detectors. Depending on the situation, either or both of modulating or adjusting the power level or levels may be used to maximize the response signal quality for variable conditions. In other words, each of the one or more EM sources may be deterministically adjusted to suit a given media response in variable operating environments, as explained herein.

Continuing the discussion of FIG. 7, at step 712, the one or more EM sources can be sequenced. The sequence can consist of one or more measurement steps, wherein each measurement step can include activating at least one EM source to reflect at least one wavelength off of the medium. Depending on the particular embodiment, the one or more EM sources may each correspond to a single wavelength or narrow band of wavelengths, or may be capable of producing more than one wavelength each. In an example sequence, one or more wavelengths would be produced over the steps, so as to produce one or more responses at the one or more wavelengths. These measurement steps can be accomplished by one or more of varying the EM source(s) that are activated or varying the wavelength(s) at which they are activated.

In certain aspects, a sequence can include multiple repeated measurement steps before being completed. For example, a set of measurements can be taken at one or more wavelengths, and then the set of measurements can be repeated one or more times before proceeding with further steps of method 700. In some situations, a sequence with a repeated set of measurements can improve the accuracy of media identification.

At step 714, for each measurement step in the sequence, the one or more EM detector(s) can make one or more readings of the intensity of the signal reflected from the medium. At step 716, a determination can be made as to whether the sequence is completed, or whether there are more measurement steps in the sequence. If there are more measurement steps, method 700 can return to step 710 for an optional ‘dark’ reference baseline reading, or can proceed directly to step 712 to perform the next measurement step in the sequence, and the corresponding one or more readings at step 714. If the sequence is completed, the method can proceed to step 718, where the results can be assembled into a measured profile, and optionally normalized. The optional normalizing can be based at least in part on the one or more ‘dark’ reference baseline readings made during method 700.

At step 720, the measured profile can be compared to one or more library profiles in a media profile library. This comparison can include calculating one or more measures of fitness (e.g., statistical or probabilistic measures such as a least squares method, etc.) to determine one or more qualities of fitness between the measured profile and the one or more library profiles. Based on this comparison, one or more likely candidates for the medium can be determined. Optionally, if the likelihood of the two or more most likely candidates is close enough to one another (e.g., within some pre-determined threshold, etc.), then the sequence of measurement steps can be repeated to obtain additional measurements before proceeding. Continuing at step 722, the results of the comparison can be output in any of a number of manners. For example, the one or more most likely candidates can be output, or all candidates can be output. After outputting results, the method can optionally return (either immediately, or after some period of time) to step 710 for an optional ‘dark’ reference baseline reading, and then to step 712 to begin a new sequence of measurement steps.

Optionally, a measure of likelihood or confidence associated with one or more candidates can be output along with the one or more candidates. Identification system errors may occur, and systems and devices of the subject innovation can declare relative confidence in the ability to identify candidate media. For example, a system of the subject innovation can be mounted on a vehicle driving on a road surface where candidate media profiles for concrete, blacktop, snow, and ice are preselected choices that the unknown medium will be compared against. As snow conditions increase the medium indication may progress from blacktop to snow in variable degrees. The result may be presented in a variety of ways, such as blacktop, ice, a most likely candidate along with an associated confidence or likelihood measure, a probability of being one or more media (e.g., 40% probability of being blacktop, 40% probabilty of being snow, 15% being ice, and 5% being concrete, etc.), etc. Furthermore, should the surface become unknown, it may be reported as such.

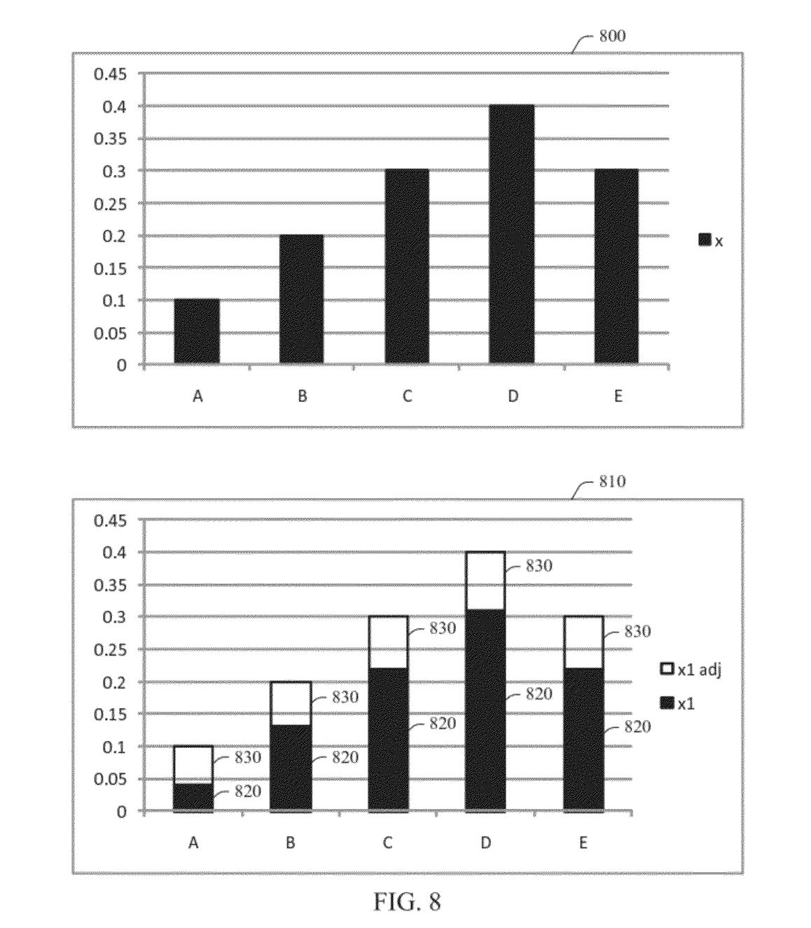

FIG. 8 illustrates an example correction that can be applied to a profile of a medium. Graph 800 depicts an example profile of a known medium, for example, as could be stored in a media profile library in accordance with aspects of the subject innovation. Graph 810 depicts a measured profile 820 of an unknown medium and a correction 830 that can be applied to measured profile 820. Such a correction can be applied in a variety of ways. For example, the intensity of one or more EM sources or the the sensitivity of one or more EM detectors can be adjusted based at least in part on a measured profile, and can optionally be followed by an additional or replacement sequence of measurements. In another example, data obtained from measurements can be adjusted based on a correction, such as by adding or subtracting a constant or linear ‘profile’ from the measured profile to obtain an adjusted profile. A correction can be selected based on various factors, such as to minimize a calculated difference between the measured profile and one or more library profiles, based at least in part on operating conditions, such as one or more measured ‘dark’ baseline readings, etc. These one or more corrections can optionally be applied to a measured profile in connection with comparing the measured profile to one or more library profiles. As an example, in connection with the comparison, a correction can be applied to determine one or more most likely candidates corresponding to an adjusted profile, as opposed to or in addition to those corresponding to a measured profile.

In further aspects, the subject innovation can include diagnostics to ensure proper functioning. As a measure of self diagnosis, provisions for proper function can be stated by executing one or more test sequences of activations of the one or more EM sources and corresponding measurements of the one or more EM detectors to determine if the responses meet qualifying thresholds. In the presence of failed components, excess obstruction from dirt or physical damage, or certain calibration media templates, the system may make available diagnostic responses. The system can account for manual or self-corrective actions such as calling for a cleaning procedure or autonomous self-recalibration.

Additionally, by employing the use of external support equipment, such as a computer or specially developed calibration fixtures, the non-contact media detection system can be re-trained (e.g., to learn new media types, etc.), reprogrammed, serviced, maintained, recertified, etc. In various aspects, such support and similar activities can be performed on site, or remotely, for example, by using any of a number of wireless communications technologies in connection with the subject innovation for re-training, reprogramming, providing an alert or notification that service or maintenance is needed, etc.

In some aspects, such as the road treatment aspects discussed herein, the detection and identification system may be used in conjunction with road treatment materials to both determine when treatment materials should be used as well as when a road has already been treated, for example via inclusion into road treatment materials of certain add-in materials such as tracers, catalytic agents, aids, etc. For example, in an ice treatment application, the addition of one or more tracer agents (e.g., UV tracer) may be added such that the level of pre-existing ice melting agents can be more readily recognized, thus allowing for the conservation of additional treatment agents. In various aspects, systems and methods of the subject innovation can act in conjunction with systems that disperse road treatment materials (e.g., by sending instructions or other data) such that material is dispersed when certain media are detected (e.g., ice, snow, etc.), unless other media such as add-in materials like tracers, catalytic agents, aids, etc. are detected.

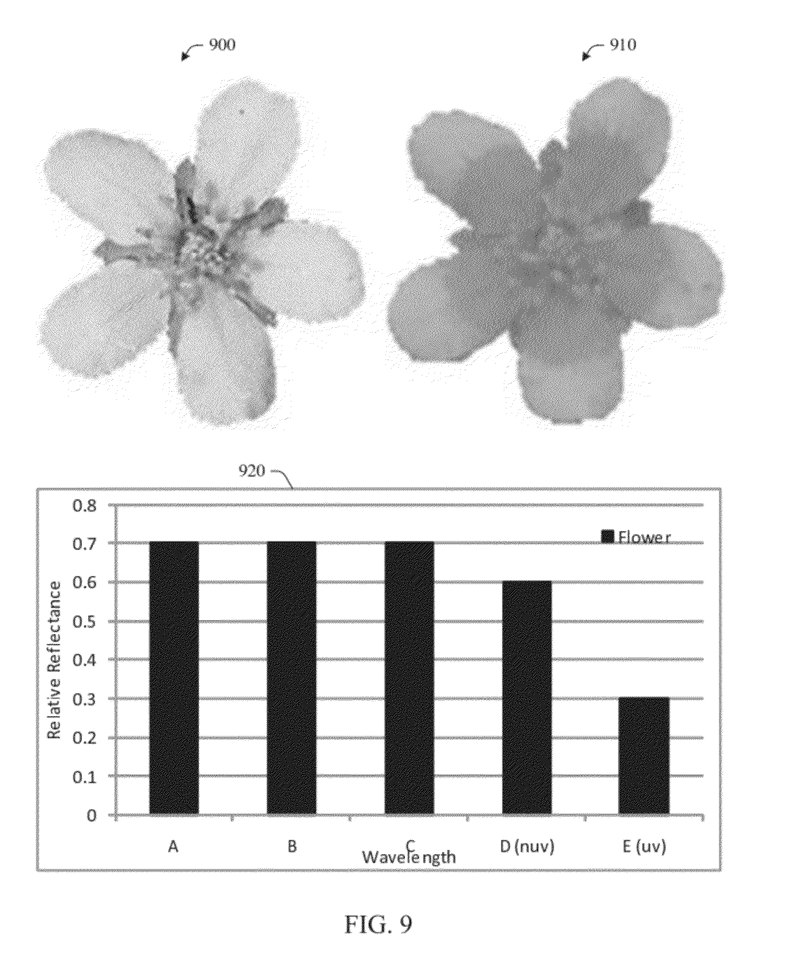

FIG. 9 illustrates photographs of a flower in the visible and ultraviolet spectrum, and a corresponding example medium profile. Photographs 900 and 910 are both photographs of the same flower. Image 900 shows the response in the visible light portion of the EM spectrum, such as can be seen by the human eye. Image 910 includes the UV EM spectrum, which is present and can be ‘seen’ by bees to locate the sweet spot. Graph 920 provides an example profile of a medium with a relatively high absorption in and near the UV portion of the spectrum, and represents the system response's higher absorption (lower reflection or albedo) of the UV content. These principles can be used in conjunction with aspects of the subject innovation to detect media based on its reflection or absorption outside of the visible spectrum, or to select and detect add-in materials for use with road treatment materials as described herein.

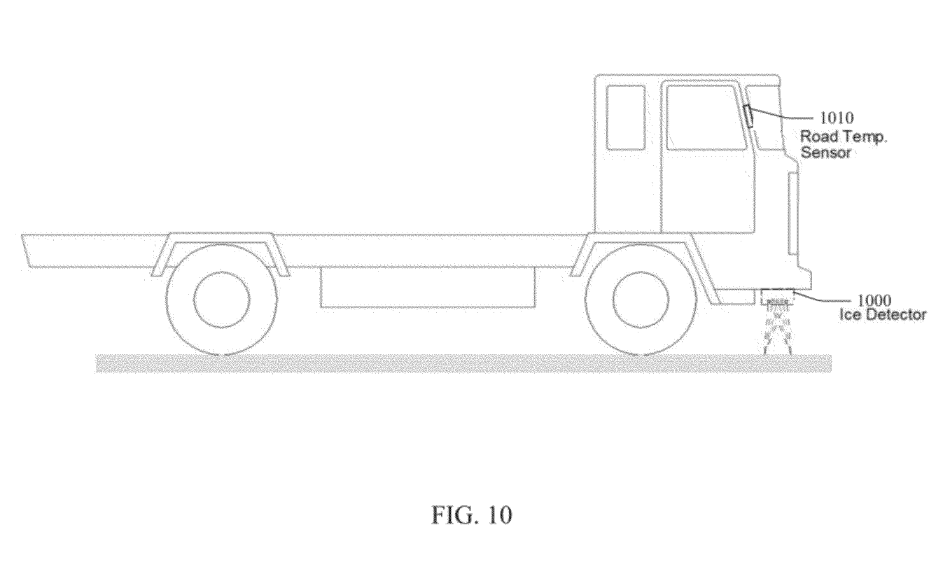

Furthermore, the invention can be used in concert with other sensing systems, such as sensors to determine an air or road temperature, for example an infrared temperature monitor to further qualify the media identification. FIG. 10 illustrates an example configuration wherein a system 1000 of the subject innovation can be used to detect media on a road surface while operating in conjunction with a sensor to detect road temperature 1010. Such a configuration can aid in media identification in multiple manners, for example, while detecting the presence of water, a temperature measurement may be examined to further conclude that the water is in a liquid, ice, or possible slurry state.

In aspects, systems and methods of the subject innovation can be used in conjunction with wireless communications techniques. For example, reprogramming or updates to a media profile library can occur remotely from a source of the reprogramming or update, and can occur while the system is deployed and operational. In other aspects, information collected by embodiments of the subject innovation can be combined. This information can be used in a variety of ways. For example, in a vehicle-mounted scenario, it could be used to build a map of road media, including road conditions (e.g., water, ice, snow, etc.), or could be used to identify roads or portions thereof that need treatment, that already have been treated, or both. In one example, this information could be used by an organization to coordinate multiple vehicles to efficiently apply treatment materials to roads where needed while minimizing effort and materials.

The subject innovation (e.g., in connection with media identification and learning new media profiles) can employ various AI-based schemes for carrying out various aspects thereof. For example, a process for learning or updating one or more media profiles can be facilitated via an automatic classifier system and process. Moreover, where the subject innovation is used to determine an unknown medium based on comparison with a library of known media profiles, the classifier can be employed to determine which profile from the media profile library best corresponds to the unknown medium.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of media identification, for example, attributes can be measured data corresponding to an unknown medium or other data-specific attributes derived from the measured data (e.g., a measured or adjusted profile), and the classes can be categories or areas of interest (e.g., library profiles that may correspond to the unknown medium).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria determining sets of most likely media candidates, determining associated likelihoods, determining an adjustment to be applied to the profile of an unknown medium, etc.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-contact media detection system, comprising:
one or more electromagnetic (EM) sources that direct EM energy toward a target surface of an unknown medium;
one or more EM detectors that measure EM energy reflected from the target surface of the unknown medium; and
a control component that receives measurement data from the one or more EM detectors, determines a measured profile based at least in part on the measurement data, and analyzes the measured profile to determine one or more likely candidates for the medium based at least in part on the analyzed profile.

2. The system of claim 1, wherein the one or more EM detectors perform a measurement when all of the EM sources are off.

3. The system of claim 2, wherein the power level of the one or more EM sources is adjusted based on the measurement performed when all of the EM sources are off.

4. The system of claim 1, wherein the one or more EM sources direct EM energy toward the target surface sequentially.

5. The system of claim 1, wherein each of the one or more EM sources is a narrow spectrum device.

6. The system of claim 1, wherein the one or more EM detectors comprise a wide spectrum device.

7. The system of claim 1, further comprising a media profile library that stores one or more known media profiles, wherein the control component determines the one or more likely candidates for the medium based at least in part on a comparison of the analyzed data to the one or more known media profiles.

8. The system of claim 7, wherein the comparison of the analyzed data to the one or more known media profiles comprises adjusting the measured profile based at least in part on a correction.

9. The system of claim 7, wherein the one or more known media profiles comprise media profiles for at least one of blacktop, asphalt, cement, concrete, dirt, gravel, rain water, snow, or ice.

10. The system of claim 7, wherein the comparison of the analyzed data to the one or more known media profiles is based at least in part on a least squares method.

11. A method of non-contact media detection, comprising:
conducting a sequence of one or more measurement steps, wherein each measurement step comprises:
activating one or more electromagnetic (EM) sources to reflect an EM signal off of an unknown medium; and
making one or more reading of an intensity of the reflected EM signal with one or more EM detectors;
assembling the one or more readings from each measurement step into a measured profile; and
determining one or more likely candidates for the unknown medium based at least in part on the measured profile.

12. The method of claim 11, further comprising making one or more reference readings of a high reflection calibration standard and adjusting at least one of the intensity of the one or more EM sources or the sensitivity of the one or more EM detectors based at least in part on the one or more reference readings.

13. The method of claim 11, wherein the sequence comprises making one or more measurements when the EM sources are powered off.

14. The method of claim 13, further comprising normalizing the measured profile based at least in part on the one or measurements made when the EM sources are powered off.

15. The method of claim 11, wherein the determining is based at least in part on comparing the measured profiles to one or more known profiles.

16. The method of claim 15, further comprising constructing a library of the one or more known profiles by taking readings of the one or more known profiles at one or more wavelengths.

17. The method of claim 15, wherein determining one or more likely candidates comprises calculating one or more fitness qualities.

18. The method of claim 11, further comprising outputting the one or more likely candidates.

19. A non-contact media detection system, comprising:
means for reflecting an EM signal off of an unknown medium at least once for each of one or more measurement steps in a sequence;
means for making one or more reading of an intensity of the reflected EM signal once for each measurement step; and
means for determining one or more likely candidates for the unknown medium based at least in part on the one or more readings of the intensity.

20. The system of claim 19, further comprising means for providing one or more known profiles, wherein the means for determining determines the one or more likely candidates based at least in part on comparing the one or more readings of the intensity to the one or more known profiles.
